(19) United States
(12) Patent Application Publication
(10) Pub. No.: US 2016/0325803 A1
(43) Pub. Date: Nov. 10, 2016

(54) HANDLESS TRANSPORT VEHICLE

(71) Applicants: Matthew Waxman, W. Babylon, NY (US); Maxx Yellin, W. Babylon, NY (US)

(72) Inventors: Matthew Waxman, W. Babylon, NY (US); Maxx Yellin, W. Babylon, NY (US)

(21) Appl. No.: 15/148,857

(22) Filed: May 6, 2016

Related U.S. Application Data
(60) Provisional application No. 62/157,500, filed on May 6, 2015.

(51) Int. Cl. B62M 7/12; B60R 11/02; B62D 11/04; B62K 21/12; B62K 3/00; B60R 1/00

(52) U.S. Cl. CPC B62M 7/12; B62K 3/007; B60R 1/00; B62K 3/002; B62D 11/04; B62K 21/12; B60R 11/0217

(57) ABSTRACT

A two-wheel, self-balancing vehicle includes a housing, at least two wheels mechanically cooperating with the housing, and a detachable handle mechanically cooperating with the housing to steer the vehicle. The two-wheel, self-balancing vehicle further includes a plurality of LED lights, one or more display screens, a plurality of USB ports, a storage compartment, and a camera. The camera may be pivoted on the housing or detachable handle portions of the two-wheel, self-balancing vehicle.

### CROSS-REFERENCE TO RELATED APPLICATIONS

This application claims priority to, and the benefit of, U.S. Provisional Patent Application Ser. No. 62/157,500, filed May 6, 2015, the entire contents of which are incorporated by reference herein.

### BACKGROUND

1. Technical Field

The present disclosure relates to a handless transport vehicle.

2. Description of Related Art

A first group of prior art two-wheel self-balancing vehicles is represented by a product known commonly as the “Segway.” This product is disclosed in U.S. Pat. No. 6,302,230, issued to Sramek et al (the '230 patent). While a contribution in the field, the Segway and like devices are disadvantageous in that they are large, heavy and expensive, i.e., too heavy to be carried by a commuter or youth, too expensive for most to buy. Furthermore, turning is achieved through a handle bar structure that ascends from the platform upward toward the chest of a user. This tall steering structure is a trip hazard when a user makes an unplanned exit from the vehicle.

Another group of prior art two-wheel self-balancing vehicles has two platform sections, each associated with a given wheel, that tilt from side-to-side as a user leans left or right. The two platform sections move in a linked or “dependent” manner (for example, through a parallelogram frame, and not independently) and there is a single “vertical” axis for the platforms. When the axis is tilted directly forward or backward, both wheels drive at the same speed (as required for self-balancing). If a user leans to the side (tilts the “vertical” axis sideways), then the outside wheel is driven faster than the inside wheel to effect a turn toward the direction of the tilt.

These devices typically require a multi-component parallelogram structure to coordinate/link movement of the two platform sections and the wheels. Such componentry adds to the weight, bulk, complexity, and potential for mechanical failure of the device. Also, the turning radius is fairly large as one wheel is typically rotating around the other (moving in the same direction though at different speeds).

A need exists for a two-wheel self-balancing vehicle that provides independent wheel control, is light-weight and compact, is easy and safe to use, and that may be made in a cost-effective manner. A need also exits for a two-wheel self-balancing vehicle that is more maneuverable and more ergonomic (functioning more naturally with the bio-mechanics of a user's legs and body) than prior art devices.

### SUMMARY

Embodiments of the present disclosure are described in detail with reference to the drawing figures wherein like reference numerals identify similar or identical elements.

An aspect of the present disclosure provides a two-wheel, self-balancing vehicle, comprising a housing; at least two wheels mechanically cooperating with the housing; and a detachable handle mechanically cooperating with the housing to steer the vehicle.

In one aspect, the vehicle includes Bluetooth speakers and a microphone.

In another aspect, the vehicle includes a plurality of LED lights or elements.

In yet another aspect, the vehicle includes a camera.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

### BRIEF DESCRIPTION OF THE DRAWING

Various embodiments of the present disclosure are described herein below with references to the drawings, wherein:

FIG. 1 is a two-wheel balancing vehicle, in accordance with embodiments of the present disclosure;

FIG. 2 is a two-wheel balancing vehicle including at least one Bluetooth speaker and a microphone, in accordance with embodiments of the present disclosure;

FIG. 3 is a two-wheel balancing vehicle including a plurality of USB ports, in accordance with embodiments of the present disclosure;

FIG. 4 is a two-wheel balancing vehicle including one or more auxiliary inputs, in accordance with embodiments of the present disclosure;

FIG. 5 is a two-wheel balancing vehicle including one or more buttons to toggle between different audio options, in accordance with embodiments of the present disclosure;

FIG. 6 is a two-wheel balancing vehicle including at least one camera and a means for wireless communication between the at least one camera and a portable electronic device, in accordance with embodiments of the present disclosure;

FIG. 7A is a two-wheel balancing vehicle including a plurality of LED elements, in accordance with embodiments of the present disclosure;

FIG. 7B is a two-wheel balancing vehicle including an alternative embodiment of a plurality of LED elements, in accordance with embodiments of the present disclosure;

FIG. 8 is a two-wheel balancing vehicle including a plurality of display screens, in accordance with embodiments of the present disclosure;

FIG. 9 is a two-wheel balancing vehicle including at least one warning means or horn, in accordance with embodiments of the present disclosure;

FIG. 10 is a two-wheel balancing vehicle including at least two retractable hooks, in accordance with embodiments of the present disclosure;

FIG. 11 is a two-wheel balancing vehicle including training wheels, in accordance with embodiments of the present disclosure;

FIG. 12 is a two-wheel balancing vehicle including a detachable handle bar, in accordance with embodiments of the present disclosure;

FIG. 13 is a two-wheel balancing vehicle including a detachable handle bar with a clip mechanism, in accordance with embodiments of the present disclosure;

FIG. 14 is a two-wheel balancing vehicle including retractable handle bars that retract from the housing upon actuation, in accordance with embodiments of the present disclosure;

FIG. 15 is a two-wheel balancing vehicle including a locking mechanism, in accordance with embodiments of the present disclosure; and

FIG. 16 is an app that communicates with the two-wheel balancing vehicle to control or monitor or track one or more functions of the two-wheel balancing vehicle, in accordance with embodiments of the present disclosure.

The figures depict embodiments of the present disclosure for purposes of illustration only. One skilled in the art will readily recognize from the following disclosure that alternative embodiments of the structures and methods illustrated herein may be employed without departing from the principles of the present disclosure described herein.

### DETAILED DESCRIPTION

Although the present disclosure will be described in terms of specific embodiments, it will be readily apparent to those skilled in this art that various modifications, rearrangements and substitutions may be made without departing from the spirit of the present disclosure. The scope of the present disclosure is defined by the claims appended hereto.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The term “electronic device” may refer to one or more personal computers (PCs), a standalone printer, a standalone scanner, a mobile phone, an MP3 player, gaming consoles, audio electronics, video electronics, GPS systems, televisions, recording and/or reproducing media (such as CDs, DVDs, camcorders, cameras, etc.) or any other type of consumer or non-consumer analog and/or digital electronics. Such consumer and/or non-consumer electronics may apply in any type of entertainment, communications, home, and/or office capacity. Thus, the term “electronic device” may refer to any type of electronics suitable for use with a circuit board and intended to be used by a plurality of individuals for a variety of purposes. The electronic device may be any type of computing and/or processing device.

The term “processing” may refer to determining the elements or essential features or functions or processes of one or more handless transport systems for computational processing. The term “process” may further refer to tracking data and/or collecting data and/or manipulating data and/or examining data and/or updating data on a real-time basis in an automatic manner and/or a selective manner and/or manual manner.

The term “analyze” may refer to determining the elements or essential features or functions or processes of one or more handless transport for computational processing. The term “analyze” may further refer to tracking data and/or collecting data and/or manipulating data and/or examining data and/or updating data on a real-time basis in an automatic manner and/or a selective manner and/or manual manner.

The term “storage” may refer to data storage. “Data storage” may refer to any article or material (e.g., a hard disk) from which information may be capable of being reproduced, with or without the aid of any other article or device. “Data storage” may refer to the holding of data in an electromagnetic form for access by a computer processor. Primary storage may be data in random access memory (RAM) and other “built-in” devices. Secondary storage may be data on hard disk, tapes, and other external devices. “Data storage” may also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “module” or “unit” may refer to a self-contained component (unit or item) that may be used in combination with other components and/or a separate and distinct unit of hardware or software that may be used as a component in a system, such as a handless transport system. The term “module” may also refer to a self-contained assembly of electronic components and circuitry, such as a stage in a computer that may be installed as a unit. The term “module” may be used interchangeably with the term “unit.”

A two-wheel vehicle self-balancing device is described, also referred to as “device” or “vehicle” or “two-wheel vehicle” or “two-wheel device” throughout this description. The two-wheel vehicle includes bigger air filled tires with suspension for off-roading. The bigger tires enable such device or system to be used in a variety of different applications. For example, for off-road adventures, such as, but not limited to, hunting. The two-wheel vehicle device also includes a faster and lighter motor that makes the two-wheel vehicle operate at a faster speed. Additionally, the battery life of the two-wheel vehicle is much longer than any other conventional devices. Moreover, the two-wheel vehicle may be constructed from a different set of materials, such as with a rubber-like material that doesn't get damaged or scuffed up.

The housing may be formed of metal, sturdy plastic or other suitable material. The housing members may be molded and incorporate strengthening reinforcements, and be shaped to receive and “nest” the internal components (discussed below) of the vehicle. The bottom and top housing sections are formed complementarily so that after the internal components are installed, the top housing section is fitted onto the bottom housing section and secured with screws or other fasteners.

In one exemplary embodiment, the two-wheel vehicle includes Bluetooth connectivity. Therefore, a Bluetooth speaker may be installed on one or more portions of the two-wheel vehicle.

In another exemplary embodiment, a built-in microphone can be installed so that a user can talk into the device while the user is riding the device. The built-in microphone may be installed in a discrete location such that it does not interfere aesthetically with the overall appearance of the device. One skilled in the art may contemplate a number of different housing configurations that are designed to account for or accommodate the components of the speaker.

In another exemplary embodiment, the two-wheel vehicle has the capability to play AM/FM radio. An auxiliary input may be included to allow a user to plug an electronic device into the two wheel vehicle and use the speaker itself. Thus, the two-wheel vehicle has the capability to be able to play music or emit sounds from any application on the electronic device connected thereto that syncs with the two-wheel device.

In another exemplary embodiment, an input means, such as a button may be presented to the user that allows the user to toggle between different audio options, such as, Wireless Bluetooth, Radio, and any type of Auxiliary inputs.

In another exemplary embodiment, the built-in Bluetooth speaker has the capability to sync with maps and provide the user with directions as the user rides the two-wheel vehicle. A user has the capability to turn the speaker on and off independently from the two-wheel vehicle itself. In this way, the user can use the speaker if the two-wheel vehicle is turned off. Moreover, there may be battery power for the built-in Bluetooth speaker itself. In other words, the speaker has its own independent power source so a user can continue to use the speaker, if the two-wheel vehicle is turned off or even after the two-wheel vehicle drains all of its power and turns off.

In another exemplary embodiment, a portable battery pack extender is included that plugs into the two-wheel vehicle and chargers it on-the-go. This is similar to a portable power bank that charges an electronic device on-the-go. In operation, a user would charge up the battery pack and then charge the two-wheel vehicle from the battery pack.

In another exemplary embodiment, one or more USB ports may be added. The USB ports may be incorporated on any portion of the housing or the handle bars of the two-wheel vehicle. The USB can be used to charge any type of electronic device operated by the user of the two-wheel device. Therefore, a user of the two-wheel device may also charge his/her cell phone when operating the two-wheel device.

In one instance, there could be anywhere between 1-4 ports. In another instance, there may be anywhere between 1-10 ports. One skilled in the art may contemplate any type of configurations. However, one may not want to add too many USB ports if the power source is dependent on the two-wheel power source. In an alternative embodiment, an independent power source may be used for the USB ports alone, or the same power source may be used for the Bluetooth speaker and/or some other added feature.

In another exemplary embodiment, a Bluetooth tracker is installed so that a user can track where the two-wheel device is at any time by using a website, phone, electronic device or app.

In another exemplary embodiment, the 2 individual pieces (left side and right side) may be separated for storing, transporting or traveling purposes. Therefore, the two-wheel device may be composed or formed of two different pieces. The two-wheel vehicle could also fold or be compressed in order to be stored in a compact way.

In another exemplary embodiment, a camera may be added directly onto the housing or handle bar portions of the two-wheel vehicle where a user can easily upload a video or picture using, for example, Wi-Fi. One such camera may be a GoPro camera. Of course, any type of image receiving means may used to receive images from one's immediate environment in real-time.

Moreover, a rotating camera may be installed on a pivot so a user may change the direction or angle of the camera. Therefore, the camera may be controlled or manipulated or redirected by a user as the user operates the two-wheel vehicle. For instance, the camera can face up directly aiming at a user's face or point directly in front of the user and record while moving or point directly behind the user or be pivoted relative to the two-wheel vehicle at any angle or direction or orientation that the user sees fit. The camera may also be connected directly to the user's phone or other type of electronic device. Therefore, the user has the ability to use the camera while the two-wheel vehicle is in motion.

In another exemplary embodiment, a power source may be provided that is completely independent or uses the same power supply as two-wheel vehicle.

Regarding the camera, the camera can store certain amount photos and videos. The user or the manufacturer may set the amount of memory able to be stored directly on the two-wheel vehicle. Additionally, a memory/storage disk slot and/or USB drive may be included so that a user can upload, save, and transfer photos or videos taken from the camera within the two-wheel vehicle.

In another exemplary embodiment, the two-wheel vehicle may include a storage compartment within the housing portion or the handle bar portion.

In another exemplary embodiment, the two-wheel vehicle may include different lighting configurations. For example, a plurality of different LEDs may be incorporated or embedded onto the housing portion or the handle bar portions of the two-wheel vehicle. The lighting may serve a dual purpose of aesthetics and functionality. This lighting feature would also enable the user to use the two-wheel vehicle at night time. One skilled in the art may incorporate any number of LED lights of string of lights on any portion of the device. Moreover, a user can also manipulate the LED lights by activating/deactivating one or more buttons so that a user can change the color/brightness of the LEDs.

In another exemplary embodiment, the power source may be an independent power source or same power supply used to power the two-wheel vehicle. There may be one on/off switch or multiple on/off switches that control various functions/operations of the two-wheel vehicle. For example, there may be an on/off switch on the two-wheel vehicle and/or on the key remote and/or on the electronic device.

In another exemplary embodiment, the two-wheel device includes one or more display screens having a digital speedometer that displays the current speed of the user on the two-wheel vehicle. The one or more displays may also display battery life remaining on the two-wheel vehicle, as well as which components are run from which different power supplies. The one or more displays may also display distance traveled, overall mileage, and allow the user to set different trips.

In another exemplary embodiment, the one or more displays sync with a Bluetooth speaker and control volume control, allow the user to change between different modes, etc. The one or more displays allow the user to toggle between different audio options, such as, Wireless Bluetooth, Radio, and any type of Auxiliary inputs.

In another exemplary embodiment, the two-wheel vehicle includes a horn or other type of warning or notification means. The horn may be activated as follows: (i) a weight censored footpad that the user steps on to activate the horn button, (ii) by a button on the remote key itself, and/or (iii) by using an app on the electronic device of the user.

In another exemplary embodiment, the two-wheel vehicle includes means for easy and convenient transportation. In one example, retractable turn hooks that come out the sides of the housing where the user can connect the provided strap to may be included. In another example, the strap may be stored in the storage compartment of the housing portion or the handle bar portion of the two-wheel vehicle. In another exemplary embodiment, a retractable strap may be used or a carrying bag with wheels may be provided in a package or kit.

In another exemplary embodiment, the two-wheel vehicle includes “training wheels.” These training wheels would assist the user in learning how to properly ride the two-wheel vehicle, as well as train the user in different balancing techniques.

In another exemplary embodiment, the two-wheel vehicle includes handle bars that are either retractable or detachable from the two-wheel device. The handle bar may clip on somewhere in the middle of the housing portion of the two-wheel vehicle. Alternatively, the training wheels may include a piece with a small wheel in the front and back to prevent someone from falling or helping someone with balancing on the two-wheel device. It is contemplated that the handle bars or handle mechanism easily clips on or attaches or slides on/off the two-wheel device.

In another exemplary embodiment, the two-wheel vehicle includes wheel well guards. This could be an adhesive foam cushion applied to the wheel well. This could be a certain color, logo or design or it could be some other material on just that area.

In another exemplary embodiment, the two-wheel vehicle includes a retractable or built in bike lock so a user can tie/lock it up to a fixed structure. This lock could possibly be a retractable thin, lightweight bike chain that is stored within the two-wheel vehicle. For example, it could be a latch in the middle of the two-wheel vehicle that attaches back to itself. Thus, there could be a certain way to actually lock it.

In another exemplary embodiment, the two-wheel vehicle interacts with one or more apps of an electronic device. The app would allow the user to control, monitor, and track a variety of different features and components. For example, the app could control or track or monitor distance traveled, total distance, trips, time, lighting, change the color of the lights, brightness, turn it on/off, speedometer, monitoring current speed, top speed, average speed, etc. Moreover, the app would allow the user to control, monitor, and track a variety of different features and components, such as GPS tracker so the user can track where the two-wheel vehicle is at any given time, turn the two-wheel vehicle on/off, monitor battery life for the two-wheel vehicle, monitor battery life of any other components if they run on separate power sources, lock the two-wheel vehicle so it cannot be turned on or used without approval, show a key pad where a user can enter a code in order to use it and/or lock it or turn it on/off, make it so only certain people can use the two-wheel vehicle by having their phone within reach or by connecting through Bluetooth and entering a code, and tracking nearby two-wheel vehicles.

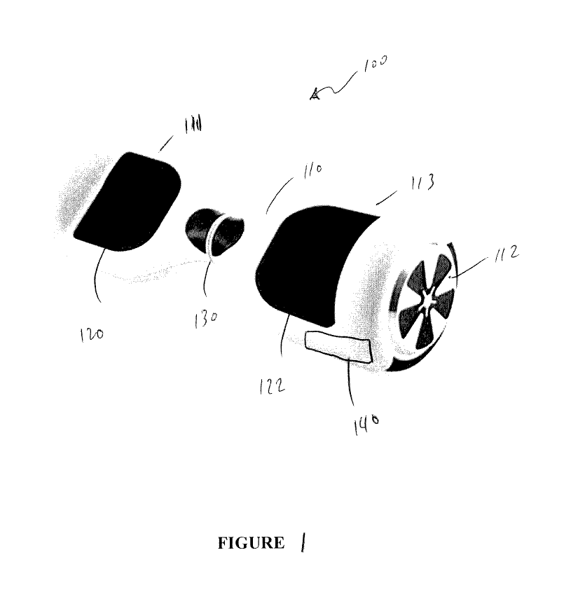

FIG. 1 is a two-wheel balancing vehicle, in accordance with embodiments of the present disclosure.

The two-wheel balancing vehicle 100 includes a housing 110, wheels 112, a first foot receiving area 120, a second foot receiving area 122, the housing including two components 111, 113 connected at a midsection or midpoint 130. The two-wheel balancing vehicle 100 further includes a storage compartment 140.

Therefore, a first foot placement section 120 and a second foot placement section 122 are coupled to one another and are independently movable with respect to one another. A first wheel 112 is associated with the first foot placement section 120 and a second wheel 112 is associated with the second foot placement section 122, the first and second wheels 112 being spaced apart and substantially parallel to one another. A first position sensor and a first drive motor are configured to drive the first wheel 112, a second position sensor and a second drive motor are configured to drive the second wheel 112. Control logic drives the first wheel 112 toward self-balancing the first foot placement section 120 in response to position data from the first sensor and drives the second wheel 112 toward self-balancing the second foot placement 122 section in response to position data from the second foot placement section 122.

The first foot placement section 120 and the second foot placement section 122 are positioned substantially linearly between the first and second wheels 112. The first and second foot placement sections 120, 122 are mounted to a frame 110 that is sufficiently flexible that the first and second foot placement platforms 120, 122 can move independently with respect to one another under the weight of a user.

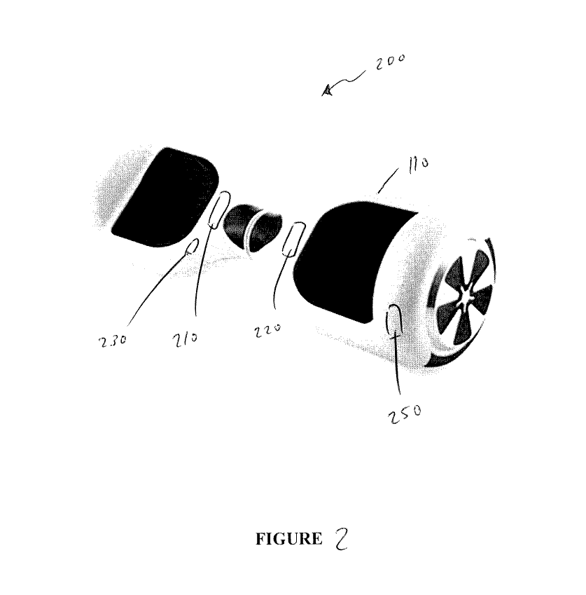

FIG. 2 is a two-wheel balancing vehicle including at least one Bluetooth speaker and a microphone, in accordance with embodiments of the present disclosure.

The two-wheel balancing vehicle 200 includes a first Bluetooth speaker 210, a second Bluetooth speaker 220, a microphone 230, and a Bluetooth tracker 250. The Bluetooth speakers 210, 220 may be incorporated on any part of the housing 110. Additionally, the microphone 230 and the Bluetooth tracker 250 may be incorporated on any part of the housing 110.

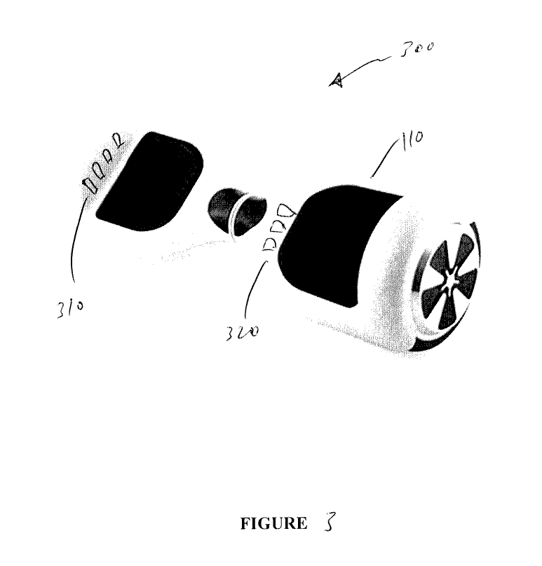

FIG. 3 is a two-wheel balancing vehicle including a plurality of USB ports, in accordance with embodiments of the present disclosure.

The two-wheel balancing vehicle 300 includes a plurality of first USB ports 310 and a plurality of second USB ports 320. USB ports 310, 320 may be incorporated on any portions of the housing 110.

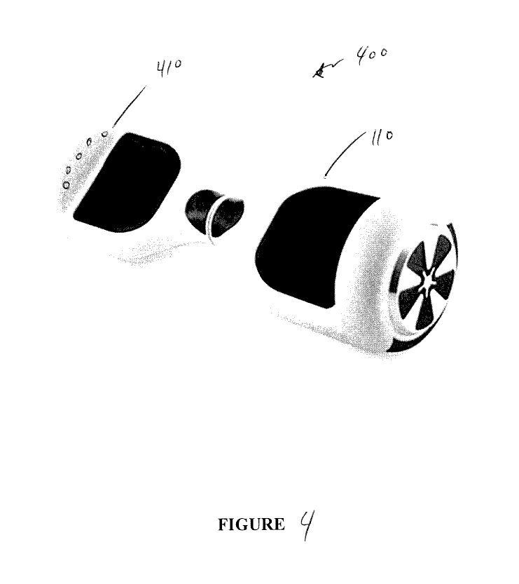

FIG. 4 is a two-wheel balancing vehicle including one or more auxiliary inputs, in accordance with embodiments of the present disclosure.

The two-wheel balancing vehicle 400 includes one or more auxiliary inputs 410. The one or more auxiliary inputs 410 may be incorporated on any portions of the housing 110.

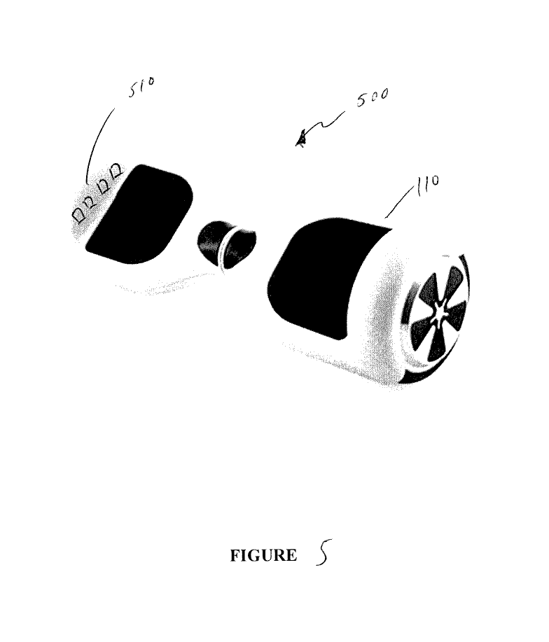

FIG. 5 is a two-wheel balancing vehicle including one or more buttons to toggle between different audio options, in accordance with embodiments of the present disclosure.

The two-wheel balancing vehicle 500 includes one or more buttons 510 to toggle between different audio options. The one or more buttons 510 may be incorporated on any portions of the housing 110.

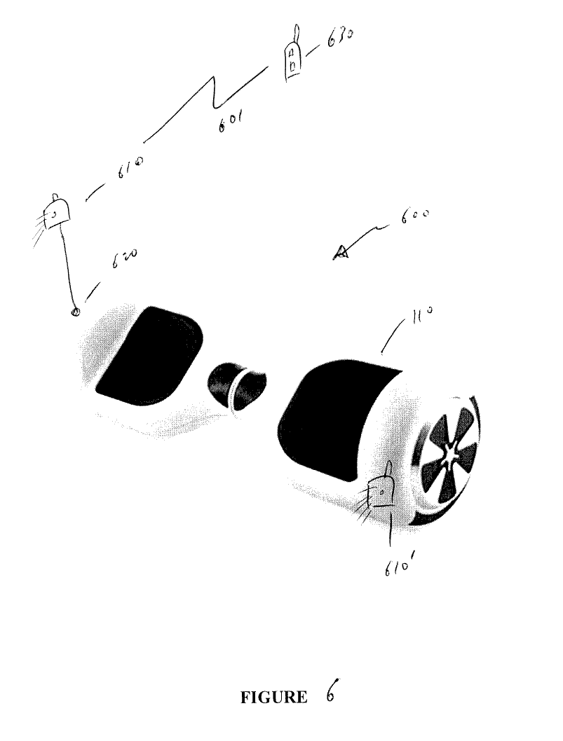

FIG. 6 is a two-wheel balancing vehicle including at least one camera and a means for wireless communication between the at least one camera and a portable electronic device, in accordance with embodiments of the present disclosure.

The two-wheel balancing vehicle 600 includes at least one camera 610, 610′ and a means 601 for wireless communication between the at least one camera 610, 610′ and a portable electronic device 630. The at least one camera 610, 610′ may be incorporated on any portions of the housing 110. The at least one camera 610, 610′ may be positioned on a pivot mechanism 620.

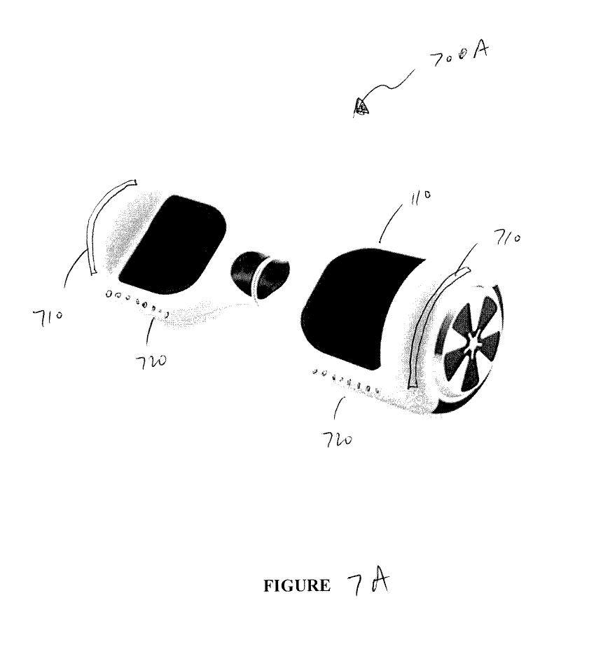

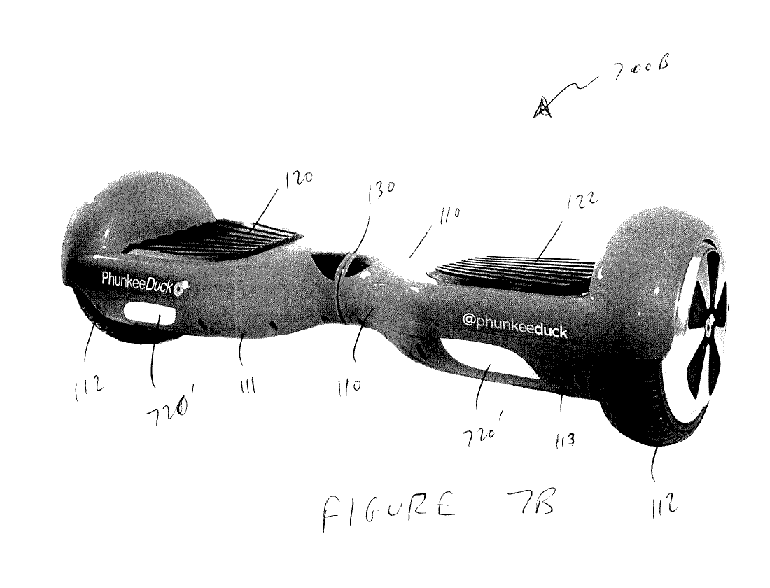

FIG. 7A is a two-wheel balancing vehicle including a plurality of LED elements, in accordance with embodiments of the present disclosure.

The two-wheel balancing vehicle 700A includes a plurality of LED elements 710, 720. The plurality of LED elements 710, 720 may be incorporated on any portions of the housing 110.

FIG. 7B is a two-wheel balancing vehicle 700B including an alternative embodiment of a plurality of LED elements 720′, in accordance with embodiments of the present disclosure.

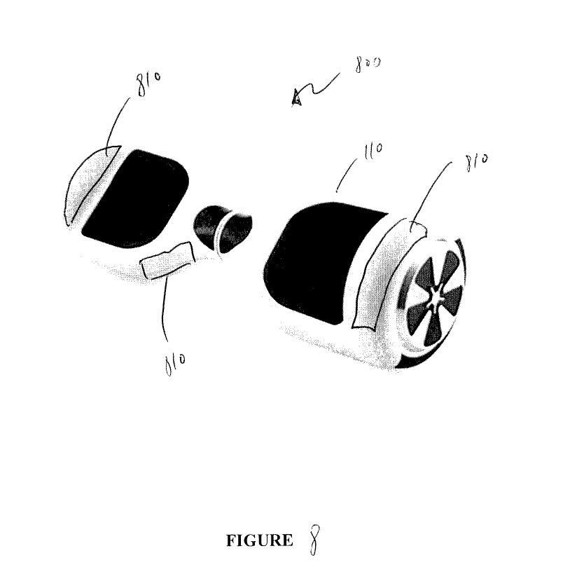

FIG. 8 is a two-wheel balancing vehicle including a plurality of display screens, in accordance with embodiments of the present disclosure.

The two-wheel balancing vehicle 800 includes a plurality of display screens 810. The plurality of display screens 810 may be incorporated on any portions of the housing 110.

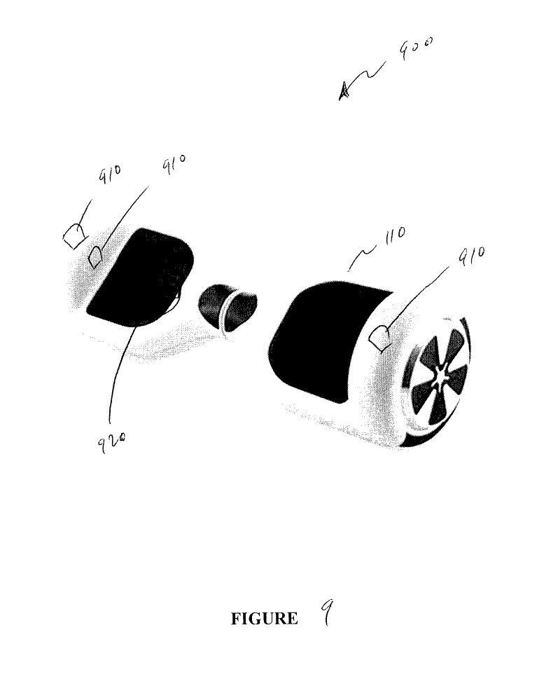

FIG. 9 is a two-wheel balancing vehicle including at least one warning means or horn, in accordance with embodiments of the present disclosure;

The two-wheel balancing vehicle 900 includes at least one warning means or horn 910. The at least one warning means or horn 910 may be incorporated on any portions of the housing 110. The horn may also be a weight censored footpad 920 on either one of the first and second foot receiving areas 120, 122.

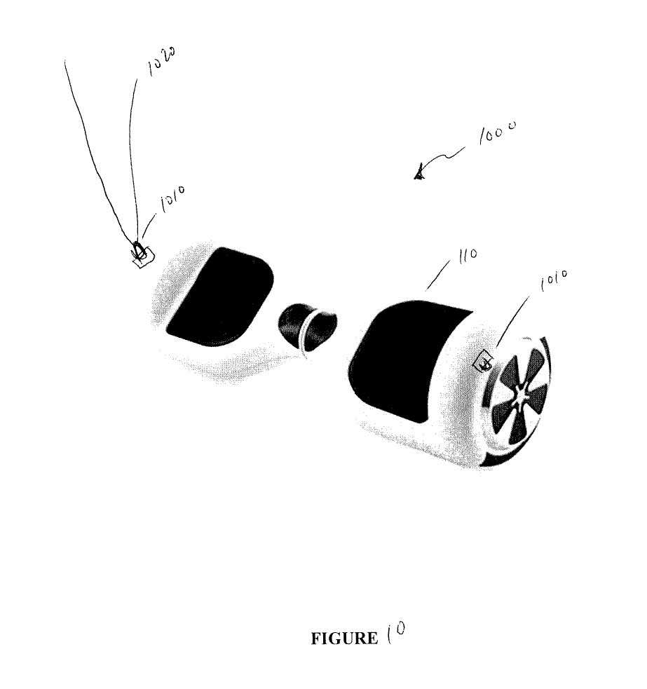

FIG. 10 is a two-wheel balancing vehicle including at least two retractable hooks, in accordance with embodiments of the present disclosure.

The two-wheel balancing vehicle 1000 includes at least two retractable hooks 1010 that are configured to receive one or more straps 1020.

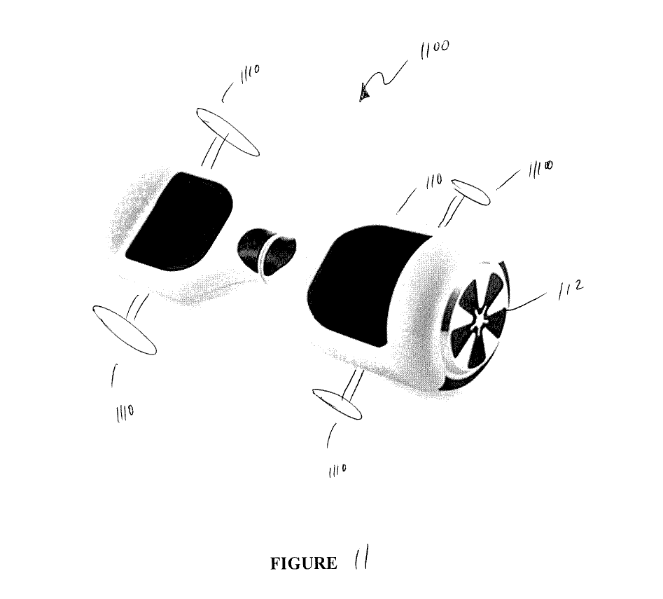

FIG. 11 is a two-wheel balancing vehicle 1100 including training wheels 1110, in accordance with embodiments of the present disclosure.

Any number of training wheels 1110 may be provided, where the training wheels 1110 aid the user in balance training. The wheels 1110 may turn or twist or rotate in any direction and may be attachable/detachable to the housing 110 of the two-wheel balancing vehicle 1100. The training wheels may be parallel to the exiting wheels 112 or may be perpendicular to the existing wheels 112. One skilled in the art may contemplate any type of configuration for attaching training wheels to the housing 110 of the two-wheel balancing vehicle 1100.

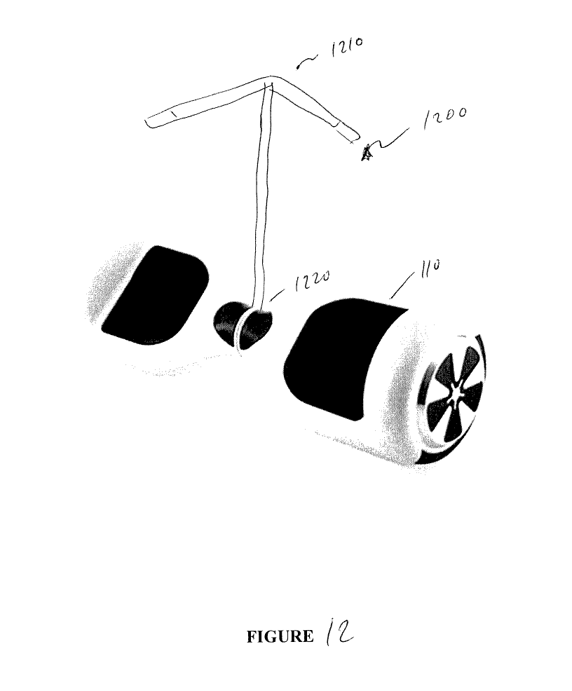

FIG. 12 is a two-wheel balancing vehicle including a detachable handle bar, in accordance with embodiments of the present disclosure.

The two-wheel balancing vehicle 1200 includes handle bars 1210. The handle bars 1210 may be used by the user to have a steady balance on the two-wheel balancing vehicle 1200. The handle bars 1210 may be detachable from the housing 110 at point 1220.

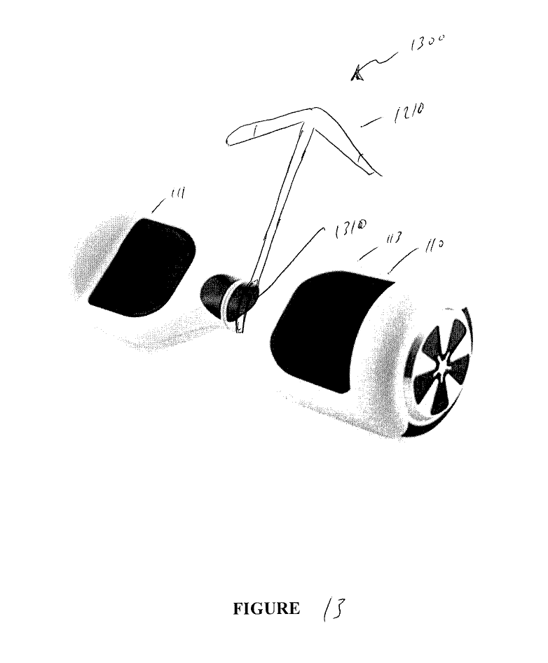

FIG. 13 is a two-wheel balancing vehicle 1300 including a detachable handle bar 1210 with a clip mechanism 1310, in accordance with embodiments of the present disclosure.

The clip mechanism 1310 may clip around or onto a portion of the housing 110 to attach/detach to/from the housing 110. The clip mechanism 1310 preferably clips somewhere between the first and second sections 111, 113 of the housing 110.

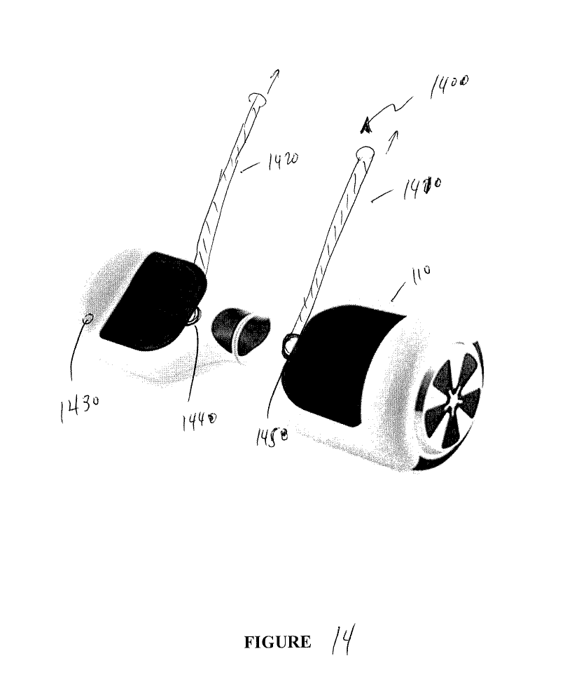

FIG. 14 is a two-wheel balancing vehicle including retractable handle bars that retract from the housing upon actuation, in accordance with embodiments of the present disclosure.

The two-wheel balancing vehicle 1400 includes a first retractable (or telescoping) bar or pole 1410 and a second retractable (or telescoping) bar or pole 1420. These retractable bars 1410, 1420 may be activated by a button 1430. The retractable bars 1410, 1420 may exit from exit or holding areas 1440, 1450, respectively. The retractable bars 1410, 1420 may be telescoping members that telescope out of the holding areas 1440, 1450 upon actuation of activation button 1430.

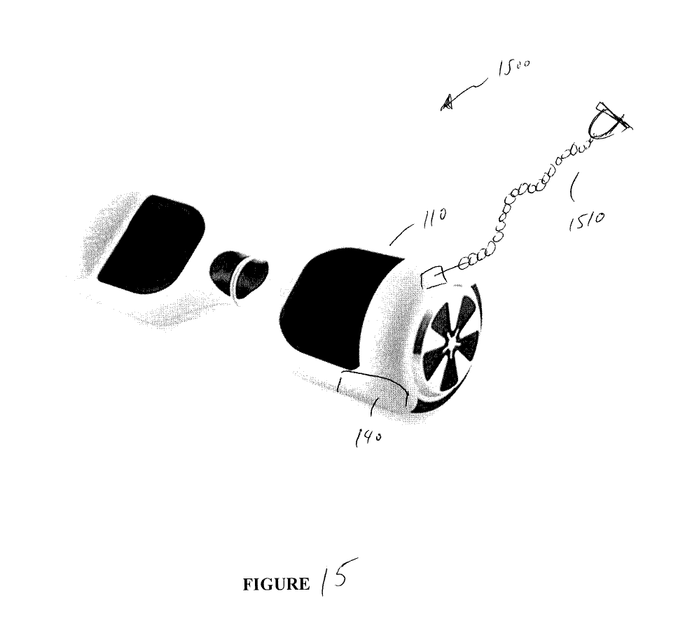

FIG. 15 is a two-wheel balancing vehicle including a locking mechanism, in accordance with embodiments of the present disclosure.

The two-wheel balancing vehicle 1500 includes a locking mechanism 1510 that may be a retractable locking mechanism or a locking mechanism stored within the storage compartment 140.

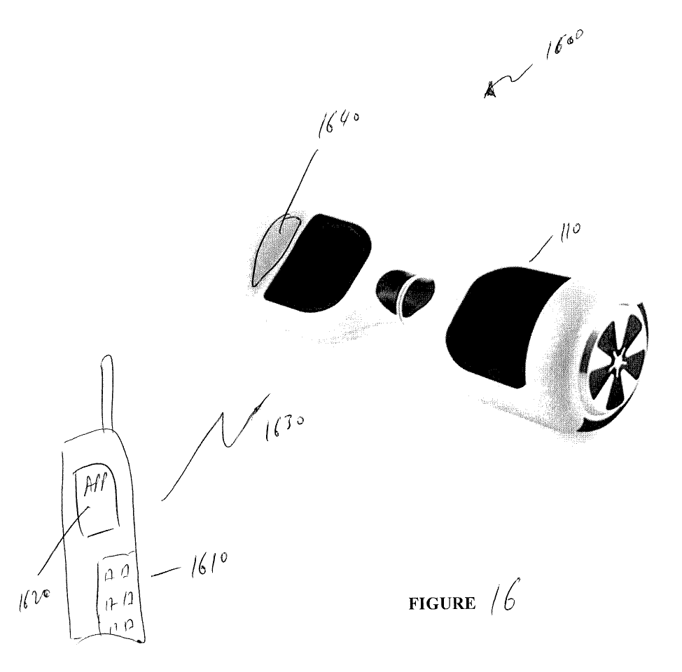

FIG. 16 is an app that communicates with the two-wheel balancing vehicle to control or monitor or track one or more functions of the two-wheel balancing vehicle, in accordance with embodiments of the present disclosure.

The two-wheel balancing vehicle 1600 includes a processor 1640 within the housing 110. The processor 1640 may communicate wirelessly 1630 with an electronic device 1610 having an app 1620. The app 1620 is configured to control or monitor or track and analyze one or more operations of the two-wheel balancing vehicle 1600.

The two-wheel vehicle may communicate with one or more servers in electrical communication with a network. An electronic device of a user is in electrical communication with the one or more servers via the network. The electronic device includes an application, as well as display hardware. The electronic device may be in communication with at least one or more operating modules of the two-wheel vehicle.

Network may be a group of interconnected (via cable and/or wireless) computers, databases, servers, routers, and/or peripherals that are capable of sharing software and hardware resources between many users. The Internet is a global network of networks. Network may be a communications network. Thus, network may be a system that enables users of data communications lines to exchange information over long distances by connecting with each other through a system of routers, servers, switches, databases, and the like.

Network may include a plurality of communication channels. The communication channels refer either to a physical transmission medium such as a wire or to a logical connection over a multiplexed medium, such as a radio channel. A channel is used to convey an information signal, for example a digital bit stream, from one or several senders (or transmitters) to one or several receivers. A channel has a certain capacity for transmitting information, often measured by its bandwidth. Communicating data from one location to another requires some form of pathway or medium. These pathways, called communication channels, use two types of media: cable (twisted-pair wire, cable, and fiber-optic cable) and broadcast (microwave, satellite, radio, and infrared). Cable or wire line media use physical wires of cables to transmit data and information. The communication channels are part of network.

Moreover, the electronic device may be a computing device, a wearable computing device, a smartphone, a smart watch, a gaming console, or a 3D television. Of course, one skilled in the art may contemplate any type of electronic device capable of streaming 3D data/information. The application may be embedded within the electronic device. However, one skilled in the art may contemplate the application to be separate and distinct from the electronic device. The application may be remotely located with respect to the electronic device.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants, and other devices that facilitate communication of information between end-users within a network.

The general features and aspects of the present disclosure remain generally consistent regardless of the particular purpose. Further, the features and aspects of the present disclosure may be implemented in system in any suitable fashion, e.g., via the hardware and software configuration of system or using any other suitable software, firmware, and/or hardware.

For instance, when implemented via executable instructions, various elements of the present disclosure are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media may include any medium that may store or transfer information.

The computer means or computing means or processing means may be operatively associated with the stereoscopic system, and is directed by software to compare the first output signal with a first control image and the second output signal with a second control image. The software further directs the computer to produce diagnostic output. Further, a means for transmitting the diagnostic output to an operator of the verification device is included. Thus, many applications of the present disclosure could be formulated. The exemplary network disclosed herein may include any system for exchanging data or transacting business, such as the Internet, an intranet, an extranet, WAN (wide area network), LAN (local area network), satellite communications, and/or the like. It is noted that the network may be implemented as other types of networks.

Additionally, “code” as used herein, or “program” as used herein, may be any plurality of binary values or any executable, interpreted or compiled code which may be used by a computer or execution device to perform a task. This code or program may be written in any one of several known computer languages. A “computer,” as used herein, may mean any device which stores, processes, routes, manipulates, or performs like operation on data. A “computer” may be incorporated within one or more transponder recognition and collection systems or servers to operate one or more processors to run the transponder recognition algorithms. Moreover, computer-executable instructions include, for example, instructions and data which cause a general purpose computer, special purpose computer, or special purpose processing device to perform a certain function or group of functions. Computer-executable instructions also include program modules that may be executed by computers in stand-alone or network environments. Generally, program modules include routines, programs, objects, components, and data structures, etc., that perform particular tasks or implement particular abstract data types.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present disclosure.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A two-wheel, self-balancing vehicle comprising:
a housing;
at least two wheels mechanically cooperating with the housing; and
a detachable handle mechanically cooperating with the housing to steer the vehicle.

2. The vehicle of claim 1, wherein the vehicle includes Bluetooth speakers and a microphone.

3. The vehicle of claim 1, wherein the vehicle includes a plurality of LEDs.

4. The vehicle of claim 1, wherein the vehicle includes a plurality of USB ports.

5. The vehicle of claim 1, wherein the vehicle includes a camera.

6. The vehicle of claim 1, wherein the housing includes a first foot placement section and a second foot placement section that are coupled to one another and are independently movable with respect to one another.

7. The vehicle of claim 6, wherein a first wheel is associated with the first foot placement section and a second wheel is associated with the second foot placement section, the first and second wheels being spaced apart and substantially parallel to one another.
